(19) United States
(12) Patent Application Publication
(10) Pub. No.: US 2026/0002860 A1
(43) Pub. Date: Jan. 1, 2026

(54) ELECTRODE PROBING STRUCTURE

(71) Applicant: INTERNATIONAL BUSINESS MACHINES CORPORATION, ARMONK, NY (US)

(72) Inventors: Frank Robert Libsch, White Plains, NY (US); Venkat Kanagraj Balagurusamy, Airmont, NY (US)

(21) Appl. No.: 18/759,768

(22) Filed: Jun. 28, 2024

(51) Int. Cl. G01N 15/12

(52) U.S. Cl. CPC G01N 15/12; G01N 2015/135

(57) ABSTRACT

An electrode probing structure includes a first array of electrodes arranged to be radially spaced apart about a spatial point. A second array of electrodes is arranged parallel to the first array of electrodes, creating a space between the first array and the second array. An inlet is disposed adjacent the first or the second array of electrodes to introduce a fluid containing particles into the space between the first and the second array of electrodes. One or more outlets are disposed adjacent the first or the second array of electrodes to remove the particles from the space between the first and second array of electrodes. Each pair of parallel electrodes of the first array of electrodes and the second array of electrodes, when provided with an electric potential, generates signals corresponding to at least one characteristic of the particles present in the space between the electrodes.

### BACKGROUND

### Technical Field

The present disclosure generally relates to particle sensors, and more particularly, to electrode probing structures used for detecting characteristics of particles in a fluid, such as a liquid or gas, and the methods of fabricating the electrode probing structures.

### Description of the Related Art

The detection of particles in fluidic environments has traditionally relied on various electrical and electrochemical sensing methods. Latest advancements in this field utilize capacitively coupled contactless conductivity detection (C4D) for the detection of particles, including biomolecules, using capillary electrophoresis. On-chip manipulation of particles using electrophoresis is widely used for many applications, including microfluidic sensing, bioanalysis, and macromolecular data collection. This method can be used for measuring small inorganic ions and organic or biochemical species without direct contact with the fluid, thereby avoiding issues such as electrode polarization and electrochemical corrosion. The low power of makes it suitable for portable, battery-powered instruments.

### SUMMARY

According to an embodiment, an electrode probing structure includes a first array of electrodes arranged to be radially spaced apart and can be symmetrical or asymmetrical about a spatial point. The spatial point may coincide with an inlet port for the particles to be detected. A second array of electrodes is arranged parallel to the first array of electrodes, creating a space between the first array of electrodes and the second array of electrodes. An inlet is disposed adjacent the first array of electrodes or the second array of electrodes to introduce particles into the space between the first array of electrodes and the second array of electrodes. One or more outlets are disposed adjacent the first array of electrodes or the second array of electrodes to remove the particles from the space between the first array of electrodes and the second array of electrodes. Each pair of parallel electrodes of the first array of electrodes and the second array of electrodes, when applied with an electric potential, generates stimulus signals corresponding to at least one characteristic of the particles present in the space between the electrodes.

In one embodiment, each of the first array of electrodes and the second array of electrodes is arranged coplanar and electrically isolated from each other.

In one embodiment, the inlet is disposed at the spatial point and the outlet is disposed at a periphery of the first array of electrodes and the second array of electrodes.

According to an embodiment, a method of fabricating an electrode probing structure includes providing a pair of substrates, each having a top surface and a bottom surface. A pair of substrates are provided each having a top surface and a bottom surface. A plurality of through-substrate vias (TSVs) are constructed from the top surface to the bottom surface of each of the pair of substrates. A plurality of metal layers and a plurality of insulator layers are deposited on each of the pair of substrates, including within the TSVs to create a pair of intermediate electrode probing structures. A plurality of electrodes and a plurality of ground shields are generated on a surface of each of the pair of intermediate electrode probing structures. A plurality of electrode contacts and a plurality of ground shield contacts are also generated, the plurality of electrode contacts and the plurality of ground shield contacts form an electrical connection with the plurality of electrodes and the plurality of ground shields, respectively. Further, the plurality of electrodes of each of the pair of intermediate electrode probing structures are arranged in parallel, creating a space between the electrodes, and at least one inlet is provided for introducing fluid containing particles to be studied into the space and at least one outlet is provided for removing the fluid from the space.

In one embodiment, depositing the plurality of metal layers and the plurality of insulator layers on the pair of substrates further includes depositing a first insulator layer over the substrates, including the TSVs and placing a photoresist on the insulator layer at the bottom surface of the substrates to define a first pattern showing areas that should not receive a metal seed layer and to generate an intermediate electrode probing structures. The metal seed layer is deposited on the top surface of each of the pair of intermediate electrode probing structures, including within the TSVs. A metal layer is deposited on this metal seed layer covering the top surface of the intermediate electrode probing structures, including the TSVs. One method of depositing a metal layer may be through a metal plating process. A second insulator layer is deposited over the intermediate electrode probing structures, including the TSVs. A photoresist and a mask are used to generate a second pattern that determines what portions of the second insulator can be etched away to define areas for generating at least a portion of the electrode contacts and ground shield contacts.

In one embodiment, a surface of the plurality of electrodes on each of the pair of intermediate electrode probing structures is smoothed by planarization to allow unimpeded laminar flow of the particles through the space between the electrodes.

In one embodiment, creating the plurality of electrode contacts and the plurality of ground shield contacts includes defining patterns for the plurality of electrode contacts and the plurality of ground shield contacts on the top surface of the intermediate electrode probing structures. Etching on the first insulator layer and the second insulator layer is performed according to the patterns defined on the top surface of the intermediate electrode probing structures. Depositing a metal on the patterns defined on the top surface of the intermediate electrode probing structures creates the plurality of electrode contacts and the plurality of ground shield contacts. In one embodiment, the creation of the space between the electrodes includes enclosing the space between the intermediate electrode probing structures using spacers. The spacers may be on the outermost peripheral or distributed at various locations between the top electrode array and the bottom electrode array, or any combination thereof. The spacers are adjustable to control a width of the space and particle flow rate.

According to an embodiment, a system for particle detection includes an electrode probing structure having a first array of electrodes and a second array of electrodes. The second array of electrodes is arranged parallel to the first array of electrodes, defining a space between the first array of electrodes and the second array of electrodes. A controller is configured to control particle flow into and out of the space between the first array of electrodes and the second array of electrodes. A data acquisition unit is configured to receive signals from the electrode probing structure. These signals are generated when an electric potential is applied to each pair of parallel electrodes of the first array of electrodes and the second array of electrodes. A processor analyses the received signals to determine at least one characteristic of the particles in the space between the pairs of parallel electrodes.

In one embodiment, the electrode probing structure includes an inlet disposed at a spatial point from which the plurality of electrodes of the first array of electrodes and the second array of electrodes are arranged symmetrically and radially spaced apart. The inlet is used to introduce particles into the space between the first array of electrodes and the second array of electrodes. One or more outlets are disposed at a periphery of the first array of electrodes or the second array of electrodes to remove the particles from the space.

In one embodiment, the processor is configured to determine characteristics of the particles, such as type, size, number, motion characteristics, and time to completely fill the space between the first and second arrays of electrodes as a function of the particle flow rate.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 depicts a top view of a first array of electrodes of an electrode probing structure in accordance with an illustrative embodiment.

FIG. 2 depicts a front cross-sectional view of an electrode probing structure including the first or second array of electrodes shown in FIG. 1 and a second array of electrodes in accordance with an illustrative embodiment.

FIG. 3 depicts a front cross section of a pair of parallel electrodes of an electrode probing structure in accordance with an illustrative embodiment.

FIG. 4 depicts a front cross section of a pair of parallel electrodes of an electrode probing structure in accordance with an alternate illustrative embodiment.

FIG. 5A depicts a bottom-up view of a first or second array of electrodes of an electrode probing structure in accordance with alternate illustrative embodiment.

FIG. 5B depicts a table showing a relationship between the resolution of particle measurements and the various parameters in accordance with alternate illustrative embodiment.

FIG. 5C depicts a table showing possible electrode arrangements for constructing an electrode probing structure in accordance with alternate illustrative embodiment.

FIG. 6 depicts a bottom-up view of a first or second array of electrodes of an electrode probing structure in accordance with alternate illustrative embodiment.

FIG. 7 depicts a bottom-up view of a first or second array of electrodes of an electrode probing structure in accordance with alternate illustrative embodiment.

FIG. 8 depicts a bottom-up view of a first or second array of electrodes of an electrode probing structure in accordance with alternate illustrative embodiment.

FIG. 9 depicts a bottom-up view of a first or second array of electrodes of an electrode probing structure in accordance with alternate illustrative embodiment.

FIG. 10 depicts a cross-section view of a substrate for use in a fabrication sequence of an electrode probing structure in a fabrication sequence of an electrode probing structure in accordance with an illustrative embodiment.

FIG. 11 depicts a cross-section of an intermediate semiconductor structure of the electrode probing structure depicting one or more through-substrate vias (TSVs) processed on the substrate in a fabrication sequence of the electrode probing structure in in accordance with an illustrative embodiment.

FIG. 12 depicts a cross-section of an intermediate semiconductor structure of the electrode probing structure depicting the deposition of a first insulator layer on the substrate, including the one or more TSVs shown in FIG. 11, as a step in the fabrication sequence of the electrode probing structure in accordance with an illustrative embodiment.

FIG. 13 depicts a cross-section of an intermediate semiconductor structure of the electrode probing structure depicting using a photoresist on a bottom surface of a substrate in a fabrication sequence of the electrode probing structure in accordance with an illustrative embodiment.

FIG. 14 depicts a cross-section of an intermediate semiconductor structure of the electrode probing structure depicting the deposition of a metal seed layer on a top surface of a substrate, in a fabrication sequence of the electrode probing structure in accordance with an illustrative embodiment.

FIG. 15 depicts a cross-section of an intermediate semiconductor structure of the electrode probing structure depicting the plating of a first metal layer over a metal seed layer in a fabrication sequence of the electrode probing structure in accordance with an illustrative embodiment.

FIG. 16 depicts a cross-section of an intermediate semiconductor structure of the electrode probing structure depicting the deposition of an additional insulator layer over the top and bottom surfaces of the substrate in a fabrication sequence of the electrode probing structure in accordance with an illustrative embodiment.

FIG. 17 depicts a cross-section of an intermediate semiconductor structure of the electrode probing structure depicting generating a pattern for the etching on insulator material in a fabrication sequence of the electrode probing structure in accordance with an illustrative embodiment.

FIG. 18 depicts a cross-section of an intermediate semiconductor structure of the electrode probing structure depicting etching to remove portions of insulator layer in a fabrication sequence of the electrode probing structure in accordance with an illustrative embodiment.

FIG. 19 depicts a cross-section of an intermediate semiconductor structure of the electrode probing structure depicting depositing a metal seed layer in a fabrication sequence of the electrode probing structure in accordance with an illustrative embodiment.

FIG. 20 depicts a cross-section of an intermediate semiconductor structure of the electrode probing structure depicting performing generating patterns for electrodes and electrode contacts in a fabrication sequence of the electrode probing structure in accordance with an illustrative embodiment.

FIG. 21 depicts a cross-section of an intermediate semiconductor structure of the electrode probing structure depicting depositing metal into generated patterns formed to create the electrodes and the electrode contacts in a fabrication sequence of the electrode probing structure in accordance with an illustrative embodiment.

FIG. 22 depicts a cross-section of an intermediate semiconductor structure of the electrode probing structure depicting depositing a second insulator layer in a fabrication sequence of the electrode probing structure in accordance with an illustrative embodiment.

FIG. 23 depicts a cross-section of an intermediate semiconductor structure of the electrode probing structure depicting a planarization of top and bottom surfaces in a fabrication sequence of the electrode probing structure in accordance with an illustrative embodiment.

FIG. 24 depicts a cross-section of an intermediate semiconductor structure of the electrode probing structure depicting generating further patterns in a fabrication sequence of the electrode probing structure in accordance with an illustrative embodiment.

FIG. 25 depicts a cross-section of an intermediate semiconductor structure of the electrode probing structure depicting developing dual and insulator etches in a fabrication sequence of the electrode probing structure in accordance with an illustrative embodiment.

FIG. 26 depicts a cross-section of an intermediate semiconductor structure of the electrode probing structure depicting performing a metal deposition to create electrode and ground shield contacts in a fabrication sequence of the electrode probing structure in accordance with an illustrative embodiment.

FIG. 27 depicts a cross-section of an intermediate semiconductor structure of the electrode probing structure depicting the assembly and bonding of the pair of substrates formed as shown in FIG. 26 in a fabrication sequence of the electrode probing structure in accordance with an illustrative embodiment.

FIG. 28 depicts a flowchart of a method of fabrication of an electrode probing structure in accordance with an illustrative embodiment.

FIG. 29 depicts a system for particle detection in accordance with an illustrative embodiment

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a chip.

As used herein, the term “vertical” describes an orientation that is arranged perpendicular to the first surface of a chip, chip carrier, or semiconductor body.

As used herein, the terms “coupled” and/or “electrically coupled” are not meant to mean that the elements must be directly coupled together—intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used and structural or logical changes may be made without departing from the spirit and scope defined by the claims. The description of the embodiments is not limiting. In particular, elements of the embodiments described hereinafter may be combined with elements of different embodiments.

The concepts herein relate to electrode probing structures used for detecting particles including organic particles such as bacteria, viruses, and other biomolecules such as DNA and proteins, and inorganic particles present in a fluid. In one or more embodiments, the electrode probing structures can be used to identify, the characteristics of these particles, such as, but not moted to, size, number, dynamics of the particles in the fluid. In various other embodiments, a method of fabricating these electrode probing structures is disclosed.

The fundamental principle of such an electrical-based sensor involves applying a current or voltage to selected electrodes in contact with or adjacent to particles or the fluid (such as a liquid or gas) containing the particles and identifying the effect of the current or voltage stimulus on the fluid. This applied stimulus measures the opposition of the fluid containing the particles, resulting in a unique impedance. This impedance, which has a real or resistance component and an imaginary or reactance component, can be detected by the same or other electrodes to help identify the particle or its characteristics. The reactance component, is typically influenced by changes in the position, quantity, or other properties of the fluid containing the particles or by the frequency of the stimulus, which forms the basis of capacitive sensing. These capacitive sensors operate by varying any of the three parameters of a capacitor, i.e., distance between the electrodes (d), area of the electrodes (A), and dielectric constant (εᵣ) of the material, fluid filled within a space or gap between the electrodes. Various sensors have been developed based on these principles, each optimized for specific applications.

The electrode probing structure utilizes a capacitively coupled contactless conductivity detection (C4D) method for particle detection, using capillary electrophoresis. The fluid may be allowed to freely pass through a space, gap, or channel formed by one or more electrodes in the electrode probing structure. When an electric field is applied between the electrodes, and the fluid passes through this space, the resulting capacitance or impedance generated by each pair of electrodes forming a cell is measured and analyzed. This analysis considers various parameters, such as the width of the space, flow rate, area of the electrodes, and the number of electrodes, to determine the characteristics of the particles present in the fluid passing through the space between the electrodes. For accurate detection of particle characteristics with the desired resolution and sensitivity, the electrode probing structures may allow controlled flow of particles through the space, gap, or channel formed between the electrodes. Controlling the flow rate of the fluid through the space between the electrodes enhances particle tracking.

Conventionally, the flow state of a fluid can determine the accuracy of the measurements. A linear flow of particles through a tubular channel can cause sidewall-impeded flow, which can restrict particle movement. This may result in a non-uniform flow rate that affects measurement accuracy. The shape and dimensions of the electrodes surrounding the gap, space, or fluid flow channel may also impact accuracy. Using flat or planar electrodes for detecting particle characteristics can provide more accuracy and can be associated with simpler calculations than using complex, non-planar electrodes such as, but not limited to, concave, or curved electrodes. The shape of the electrodes also affects scalability. Flat or planar electrodes can be easily fabricated and are more easily scalable due to the radius of curvature not changing compared to non-planar, concave or curved electrodes where the radius of curvature changes with scaling. Additionally, flat or planar electrodes may allow for simple 1D/2D non-overlapping mapping of electrodes (as opposed to a conventionally complex 2D/3D interdependent mapping of electrodes caused by overlapping, concave or curved electrodes), creating a more accurate particle flow image.

In embodiments herein, the accurate measurement of particle characteristics in a fluid using electrode probing structures based on the C4D method depends on various factors, including flow rate, electrode area, number of electrodes, mode of electrode arrangement, and time sampling.

In one embodiment, an electrode probing structure facilitates a radial fluidic flow to detect particles by bypassing sidewall interaction, thereby allowing particles to flow freely. The electrode probing structure may handle a wide spectrum of particle flows, from no movement in sealed conditions to dynamic flows, and may be scaled to detect both nanoparticles and individual particles by adjusting the width of the space, gap or the microfluidic channel and electrode dimensions. The electrode probing structure may further be configured to provide flexible resolution through the adjustment of four key parameters such as flow rate, cell area, number of electrodes, and time sampling, ensuring an optimal balance between cost and signal-to-noise (S/N) ratio. Further, the electrode probing structure employs appropriate electrode fabrication methods for arrangement of electrodes to avoid issues with electromagnetic interference and crosstalk between adjacent electrodes, improving accuracy. The electrode probing structure supports both encapsulated and unencapsulated electrodes, allowing for an optimal tradeoff between the S/N ratio and fluid interaction complexity. Specifically, in some applications, it may be desirable to either protect the electrodes from an assay, or vice versa. To do this, probes in the microfluidic channel of the assay can be passivated/protected with a deposited thin insulator (non-electrically shorting) film (such as SiO2, SiNx, etc.) during a microfabrication build.

Furthermore, the electrode probing structure can incorporate differential sensing techniques for highly sensitive detection, enabling the detection of very low concentrations of particles in a fluid, and the early detection of emerging or changing species. This capability can support mobile, field-based detection, significantly reducing the long incubation times previously necessary in laboratory settings. In its most basic form, the sensor measures reactance, factoring in design parameters such as electrode distance (d), area (A), and dielectric constant (εᵣ). The radial structure of the electrodes, measurement method, and fabrication technique as described herein allow for unrestricted particle flow rates, thereby enhancing detection accuracy and scalability.

Accordingly, the teachings herein provide an electrode probing structure and a method of fabricating this electrode probing structure. Additionally, a system utilizing the electrode probing structure is disclosed for detecting particles and their characteristics. The techniques described can be implemented in various ways. Example implementations are provided below with reference to the following figures.

Generally, the electrode probing structure 100 includes a first array of electrodes 102 arranged in a radial pattern, symmetrically around a spatial point 106. A second array of electrodes 104 is arranged parallel to the first array of electrodes 102, creating a space between them. The second array of electrodes 104 is arranged symmetrically, as a mirror image of the first array for electrodes 102 with the space 108 (or cavity) formed in between them. This space allows for the flow of particles or fluid containing the particles. An inlet is placed next to the first array of electrodes or the second array of electrodes. The inlet 110 introduces particles into the space between the first array of electrodes 102 and the second array of electrodes 104. Similarly, one or more outlets 112 are positioned next to the first array of electrodes or the second array of electrodes to remove particles from the space. When an electric potentials is applied to each pair of parallel electrodes of the first array of electrodes and the second array of electrodes, they generate measurable signals. These signals correspond to at least one characteristic of the particles in the space between the electrodes. The signals are then processed to identify or determine the characteristics of the particles. This arrangement allows for precise detection and analysis of particles by measuring the electrical response between the electrodes. By controlling the flow of particles through the space and applying electric potentials, various particle characteristics can be accurately determined.

### Example Electrode Probing Structure

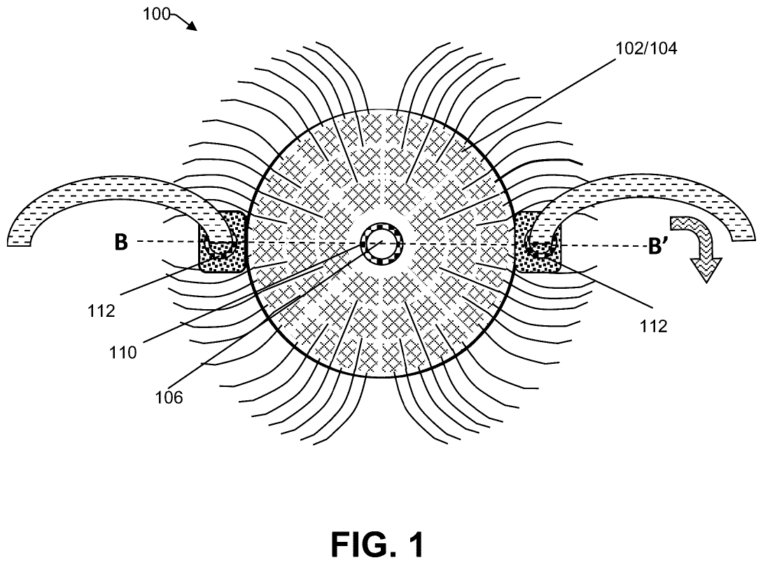

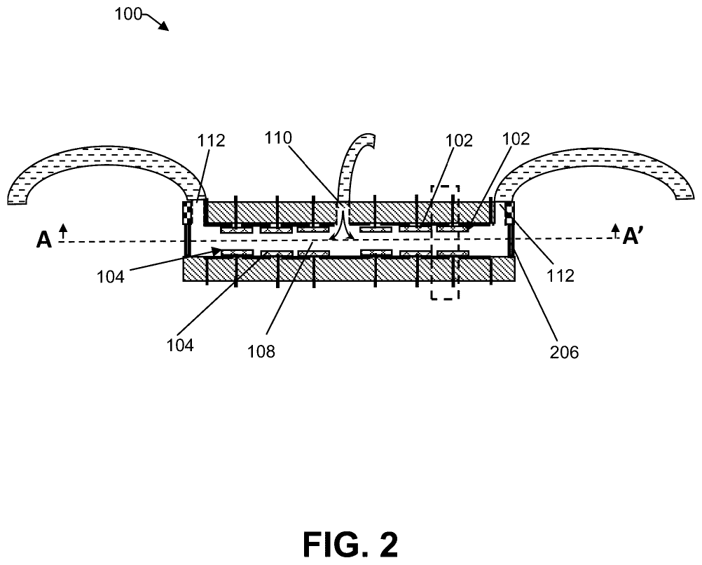

Reference is now made to FIG. 1 which depicts a top view of a first array of electrodes 102 of an electrode probing structure 100 in accordance with an illustrative embodiment and FIG. 2, which illustrates a front cross-section (through the plane B-B′ of FIG. 1) of the electrode probing structure 100. As shown in FIG. 2, the plane A-A′ divides the electrode probing structure 100 into a top half and a bottom half. The example of FIG. 1 shows a surface of either the first array of electrodes 102 or the second array of electrodes 104 in the electrode probing structure 100. In this example, the individual electrodes in both the first array of electrodes 102 and second array of electrodes 104 are coplanar. This means that the flat surfaces of the electrodes 102 in the first array of electrodes 102 lie on a single plane, and the flat surfaces of the electrodes 104 in the second array of electrodes 104 lie on a parallel plane adjacent to the first, creating the space 108 between the two planes of electrodes.

Typically, the individual electrodes 102 in both the first array of electrodes 102 and the electrodes 104 in the second array of electrodes 104 are electrically isolated from each other to prevent interference. The inlet 110 is positioned at the spatial point 106, which is arranged centrally to the first or second array of electrodes 102, 104, to introduce particles into the space 108. Outlets 112 are located at the periphery of the first array of electrodes 102 and the second array of electrodes 104, preferably on opposite sides, to ensure a smooth, radial flow of particles through the space 108 between the electrodes without causing turbulence. This setup may promote uniform distribution of particles or the fluid containing the particles. Each pair of parallel electrodes 102, 104 are individually coupled to external circuitry for data collection and analysis, ensuring each electrode pair can be monitored independently. This arrangement allows for precise detection and analysis of particle characteristics as the particles flow through the space 108 between the parallel electrodes 102, 104.

In one instance, the space 108 between the first array of electrodes 102 and the second array of electrodes 104 is adjustably enclosed using a peripheral spacer 206. In one example, the peripheral spacer 206 can be made from precision spacer balls, gaskets, or similar materials typically used in the fabrication of touch-based capacitive cells. The separation between the electrodes 102, 104 determines the height or width of the space 108 or the microfluidic channel. The channel height or width can be achieved in several ways such as during the microelectronic substrate fabrication process by depositing a thin insulator film of precise thickness, or after substrate fabrication, by joining substrates using precision spacer balls, gaskets, or similar materials. Additionally, the width of the space 108 can be adjusted to accommodate different volumes of fluid. Furthermore, the space 108 can be fully enclosed or sealed by closing the outlets 112 to take measurements when the particle or fluid is static. This flexibility allows for a wide range of experimental conditions, including dynamic flow and static measurements, enhancing the versatility of the electrode probing structure 100.

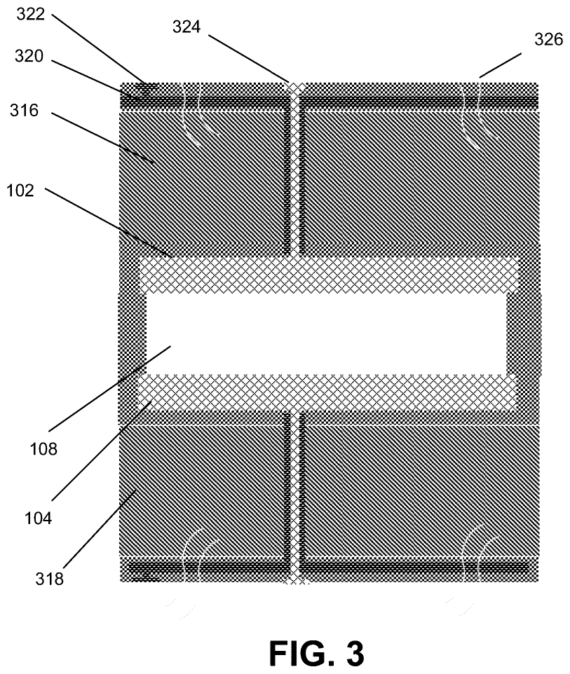

Referring now to FIG. 3, the figure depicts a front cross section of a pair of parallel electrodes 102, 104 of the electrode probing structure 100 in accordance with an illustrative embodiment. The electrode probing structure 100 includes the pair of parallel electrodes 102, 104 arranged so as to create the space 108 of desired width between the electrodes 102, 104 to allow fluid flow. The electrode 102 is deposited on a bottom surface of a first substrate 316 and electrical wire out connections from the electrode 102 are drawn through the first substrate 316 for forming electrode contacts 324 at a top surface of the first substrate 316. Similarly, ground shields 320, which are electrically isolated from the electrode 102 and the electrode contacts 324 are provided at the bottom surface of the first substrate 316 and appropriate electrical connections from the ground shields 320 are drawn through the first substrate 316 for forming ground shield contacts 322 at the top surface of the first substrate 316. The ground shield helps to prevent electrical interference 326 between the adjacent electrodes. Similarly appropriate electrode and ground shield and respective contacts are provided on a bottom substrate 318. In one or more example arrangements, the first substrate 316 may be of the same design and/or from the same fabrication substrate/wafer as the second substrate 318.

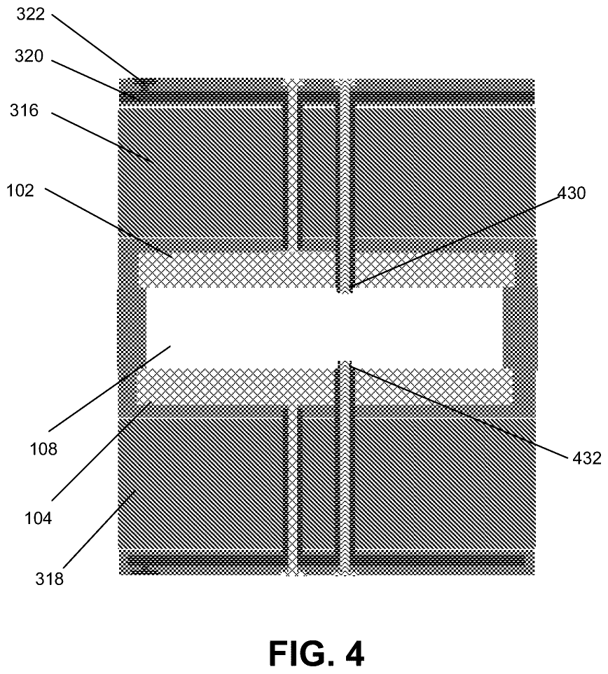

Referring now to FIG. 4, the figure depicts a front cross section of another pair of parallel electrodes 102, 104 of the electrode probing structure 100 in accordance with an alternate illustrative embodiment. Two additional probes 430, 432 are provided, one on the first substrate 316, and the other on the second substrate 318 into the space 108 between the electrodes 102, 104. In one instance, the probes 430, 432 are planar with the respective top or bottom electrodes 102, 104 or extend beyond top or bottom electrode 102, 104, respectively, in the space 108 or the microfluidic channel.

In one embodiment, the additional probes 430, 432 increase the sensitivity of the particle measurements in the space 108 between the electrodes 102, 104 by being the measurement probes independent of the stimulus electrodes 102 and 104. In one example, the width of the space 108 is determined by the placement of the first and second substrates 316, 318, which in turn affects the accuracy of the measurements. In one embodiment, the width of the space 408 is determined during microelectronic substrate fabrication of precision thickness thin insulator film deposition or after substrate fabrication during a substrate joining process by using a spacer such as a peripheral spacer which may be precision spacer balls, gaskets, etc.

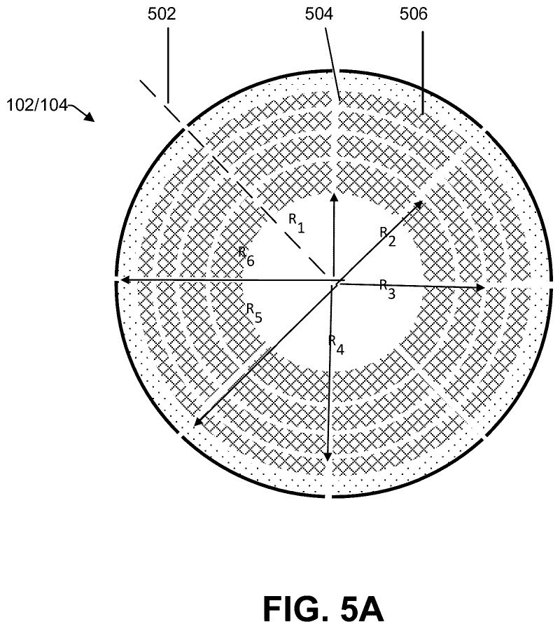

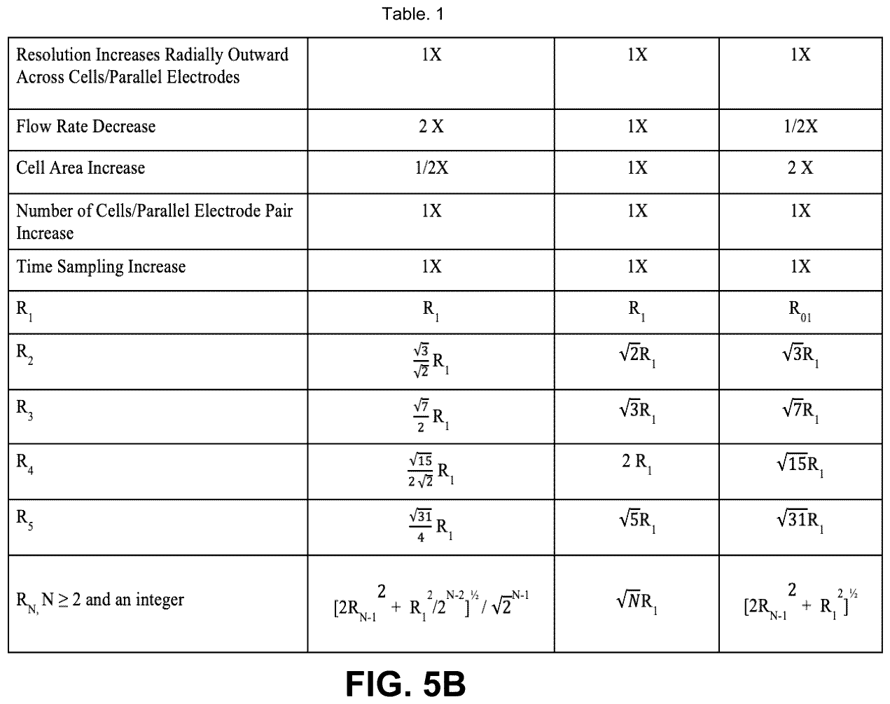

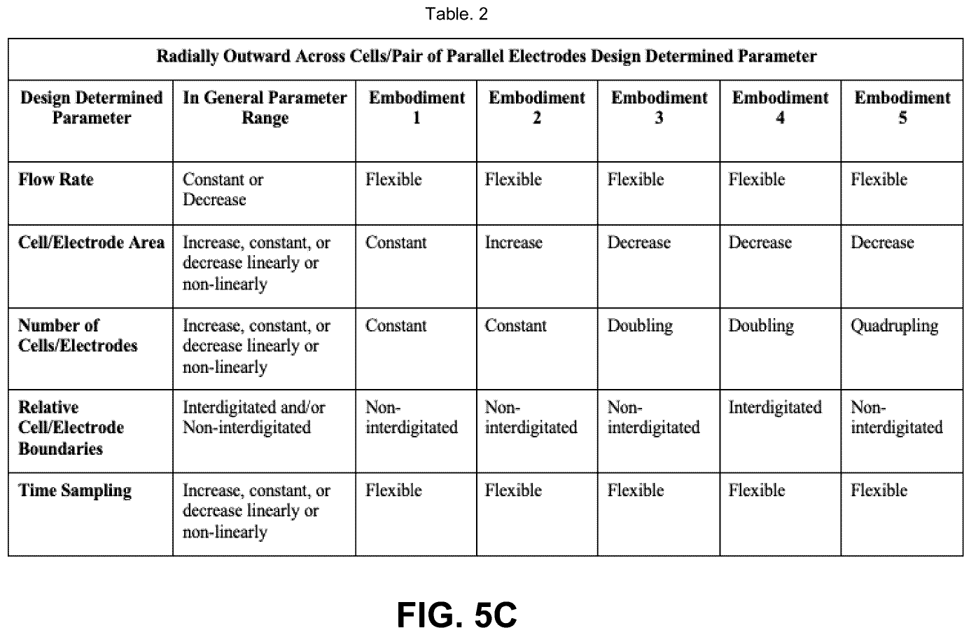

An alternate arrangement of the first array of electrodes 102 and the second array of electrodes 104 in the electrode probing structure 100 is shown in FIG. 5A in accordance with an illustrative embodiment. In this arrangement, an increment in a number of electrodes spanning a circumference, with respect to each unit increase in radius in the first array of electrodes 102 and the second array of electrodes 104 remains constant up to the periphery of the electrode probing structure 100. This means that equal number of additional electrodes are arranged with each unit increase in radius from R1 to R5 as shown in FIG. 5A. In this scenario, an area of each electrode as the radius is linearly moved from radius R1 to R5 is also kept constant. Typically, this arrangement of equal size, i.e. area and number of electrodes radially outward, e.g. from R1 to R5 is advantageous to use for comparative measurement and differential measurement schemes. With this type of electrode size arrangement, the microfluidic or gas pressure drop radially outward remains constant across any electrode centermost side to the electrode outermost side, a distance of [√(N+1)−√(N)]R1, where N is ≥1 and an integer representing the electrode ring count from the center and R1 is the radius from the center to the start of the first electrode boundary, as shown in FIG. 5A and depicted in Table 1 of FIG. 5B. The equal pressure drop across each electrode facilitates a straight-forward comparative or differential measurement analysis across any single or group of electrodes. This typically allows the measurements of the particle characteristics with high resolution.

In one instance, the electrode area can increase, decrease or remain constant with each unit increase in radius.

In one instance, the resolution of particle measurements depends on various parameters such as an increase in area of the electrodes and a change in flow rate as the fluid is allowed to radially flow from the center to the periphery of the electrode probing structure 100. FIG. 5B shows a table (Table. 1) depicting the relation between the resolution of particle measurements and the various parameters.

Typically, the resolution of the particles measurements depends directly on the area of the electrodes and the flow rate of the fluid when it flows from the center to the periphery, i.e., from R1 to R5. The electrodes 102, 104 with each increment in radius from R1 to R5 may be arranged staggered or unstaggered, yielding pairs of parallel electrodes or cells that are interdigitated or non-interdigitated, respectively. Further from Table. 1 of FIG. 5B, it is clear that the radially outward fluid flow rate will decrease to fill the expanded microchannel area. However, the radially outward fluid flow time transiting each successive radially outward cell or parallel electrodes is adjustable and can increase, decrease or remain constant from R1 to R5 depending on parameters such as decreasing, increasing or keeping constant, respectively, the cell area, under constant number of cells from R1 to R5. Another parameter of Table. 1, the number of cells or parallel electrode pairs per radial ring, is proportional to the spatial resolution of particle characterization. Table. 1 illustrates design parameter control by providing three examples in achieving a constant resolution across the electrodes as the fluid flows from R1 to R5, through the relation between the parameters such as flow rate, cell area, number of cells, and sampling time. Further, to achieve constant area of the electrodes with each increase in radius from R1 to R5, the electrodes may be concentrically arranged as shown in FIG. 5A with non-staggered boundary lines and at radii determined using the formula,

R_{N}=\sqrt{N}R₁, where N≥1 and an integer.

Referring to FIG. 5A and FIG. 6 to FIG. 9, the figures depict a bottom-up view of an electrode probing structure 100 in accordance with one or more illustrative embodiments. The electrode probing structure 100 can be a top or bottom structure which when placed in parallel are symmetrical. Table. 2 of FIG. 5C shows various possible electrode arrangements for constructing the electrode probing structures 100 shown in FIG. 5A and FIG. 6 to FIG. 9. The range of disclosed electrode probing structures 100 listed in Table. 2 are designed for flexible and high-resolution particle detection by adjusting key parameters such as flow rate, cell area, number of electrodes, and sampling time. These parameters are tailored to balance cost, resolution, and signal-to-noise (S/N) ratio, making the electrode probing structure 100 versatile for various applications.

### Embodiment 1

In the embodiment as depicted using FIG. 5A, the number and area of electrodes 102/104 remain constant as the radius increases radially outward. The flow rate transit time remains constant for each radial increment, ensuring a consistent spatial resolution across the array of electrodes. The electrodes are non-interdigitated, meaning the boundaries of the electrodes along a radial line 502, radial boundaries 504 (as opposed to the circumferential boundaries 506 that are along a circumference) coincide with each other with each increase in radius from R1 to R5 such that they share the same radial boundary, minimizing number of adjacent cells and the resulting crosstalk and ensuring accurate particle analysis.

### Embodiment 2

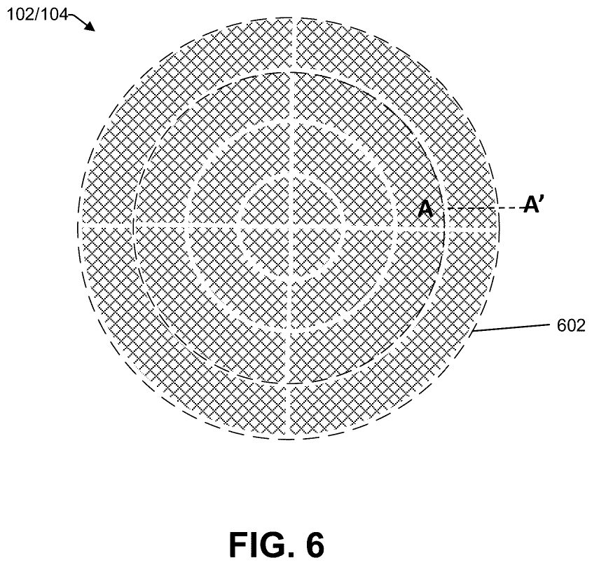

FIG. 6 shows an alternate arrangement of the electrodes 102/104 in the electrode probing structure 100, in accordance with an illustrative embodiment. In this arrangement, an increment in the number of electrodes in the first array of electrodes and the second array of electrodes is constant and an area of each of the electrodes increases with each unit increase in radius up to the outer periphery of the electrode probing structure 100. Additionally, the arrangement of electrodes in each concentric segment 602 is non-interdigitated. Cross-section A-A′ is depicted in FIG. 3. Maintaining the number of electrodes the same for each radial increment, simplifies the structure for applications where sensitivity of measurements is desired and making this setup ideal for detecting low concentrations of particles and/or of varying sizes. The non-interdigitated design minimizes the number of adjacent cells and the possible resulting interference between adjacent electrodes, ensuring high sensitivity and accurate particle analysis.

### Embodiment 3

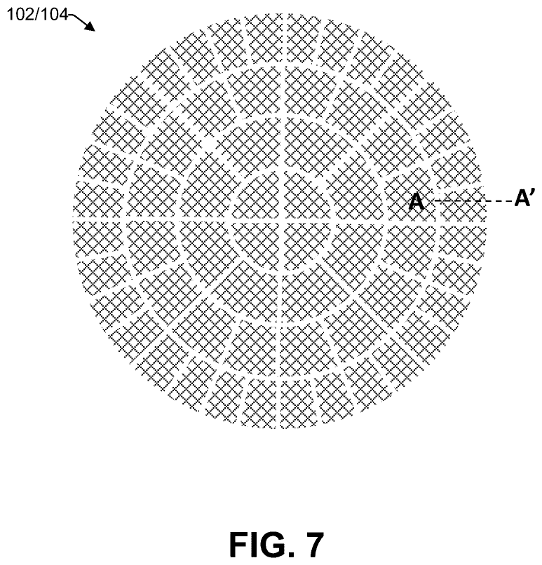

FIG. 7 shows an alternate arrangement of the electrodes 102/104 in the electrode probing structure 100, in accordance with an illustrative embodiment. Cross-section A-A′ is depicted in FIG. 3. In this arrangement, the number of electrodes in the first array of electrodes and the second array of electrodes doubles and an area of each of the electrodes decreases with each linear increase (i.e. also referred to herein as unit increase) in radius up to the outer periphery of the electrode probing structure 100. The electrode numbers doubling for each linear increase in radius provides twice the special angular directional resolution, useful for smaller particle tracking and lower radial flow rates. For a constant linear increase in radius of each circumferential electrode band, the flow time transiting each electrode is slower allowing more detection time for further enhancing the S/N detection of smaller particles. The non-interdigitated design favors simplicity when particle angular deflection is small. This non-interdigitated design further reduces the potential for cross-talk and interference, ensuring high-sensitivity and accurate particle analysis.

### Embodiment 4

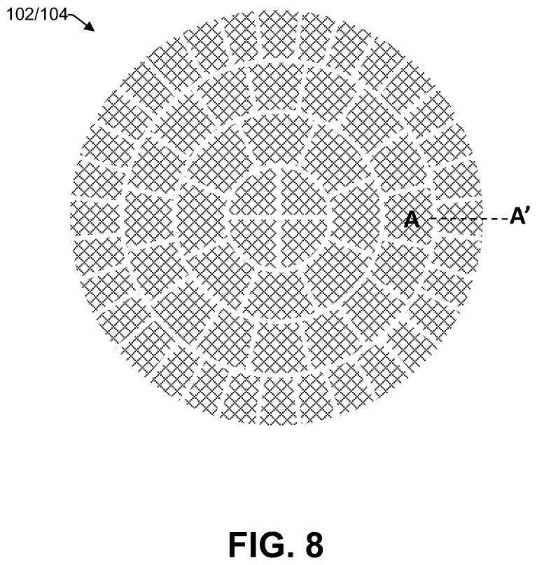

In this embodiment, an alternate arrangement of the electrodes 102/104 in the electrode probing structure 100 is shown in FIG. 8, in accordance with an illustrative embodiment. Cross-section A-A′ is depicted in FIG. 3. In this arrangement, the number of electrodes in the first array of electrodes and the second array of electrodes doubles and an area of each of the electrodes decreases with each linear increase in radius up to the outer periphery of the electrode probing structure 100. Additionally, the arrangement of electrodes in one concentric segment 602 is interdigitated relative to other concentric segments 602. This design is used for particular applications such as for differential measurements, with good angular deflection resolution, ensuring high-resolution and accurate particle analysis.

### Embodiment 5

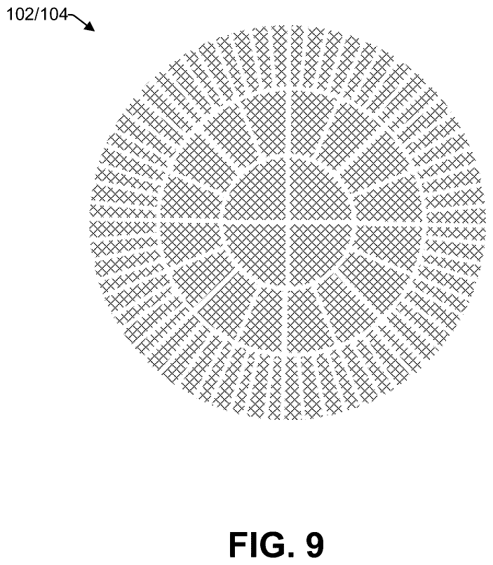

FIG. 9 shows an alternate arrangement of the electrodes 102/104 in the electrode probing structure 100, in accordance with an illustrative embodiment. In this arrangement, the number of electrodes in the first array of electrodes and the second array of electrodes quadruples and an area of each of the electrodes decreases non-linearly with each linear increase in radius up to the outer periphery of the electrode probing structure 100. This provides a non-linear higher special resolution increase up to the outer periphery. In one example, radially outward flow can be adjusted to varying decreasing levels by varying the radius of each incremental circular band of electrodes, thus providing the highest degree of customization. This setup well suited for various applications, from microfluidic sensing to large-scale fluid analysis. The non-interdigitated design maintains measurement accuracy. The resolution of the electrode probing structure 100 can be flexibly adjusted using the parameters inlet flow rate, cell area, number of electrodes, and sampling time. By manipulating these parameters, a desired optimal balance between sensitivity, cost, and signal-to-noise ratio can be achieved for specific application requirements.

In an alternate embodiment, the electrode probing structure 100 disclosed in FIG. 3 and FIG. 6 to FIG. 9 is engineered for high-resolution or high sensitivity particle detection in fluidic environments, comprising a first substrate and a second substrate, which may be of identical design and fabricated from the same substrate or wafer. This design choice involves two or more additional probes similar to the probes 430, 432 for each stimulus electrode pair 102,104 as depicted in FIG. 4 that can be either planar with the electrodes or extend beyond the top or bottom electrodes within the space or the microfluidic channel, and they can be tailored to the assay's sensitivity and specific requirements. This design allows for precise control of the width of the space or the microfluidic channel height and the integration of customizable probes to meet specific requirements.

Of course, these are not meant to be limiting as other embodiments may be obtained in view of the descriptions herein. For example, electrode placement may be such that a multitude of layout patterns such as complete or partial interdigitated patterns or non-interdigitated patterns with each unit increase in radius from the spatial point up to the outer periphery may be obtained.

### Example Method of Fabricating an Electrode Probing Structure

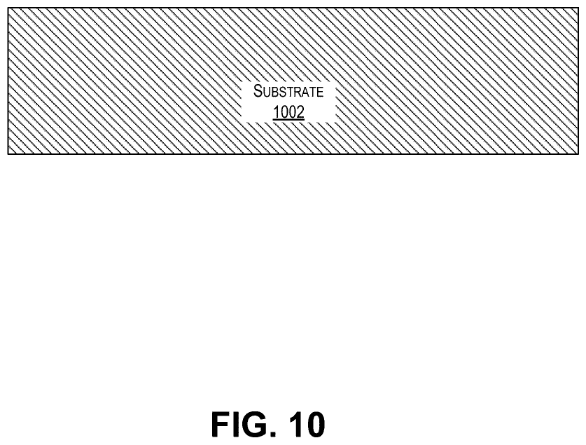

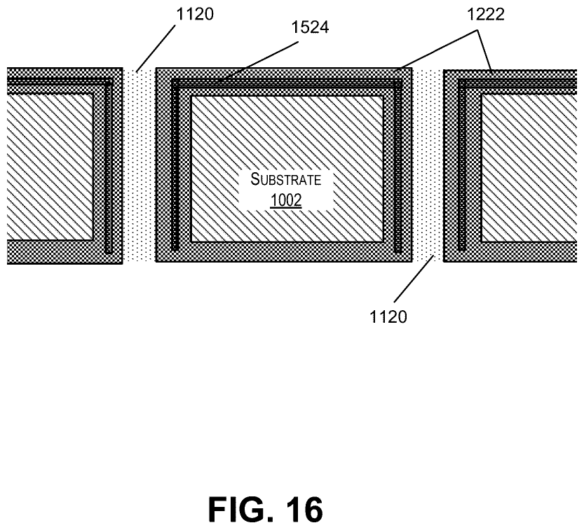

Turning now to FIGS. 10-27, an example method or process of fabricating the electrode probing structure is discussed. The figures illustrate various steps in the fabrication of an electrode probing structure, consistent with illustrative embodiments. For the sake of brevity, conventional techniques related to semiconductor device and integrated circuit (IC) fabrication may or may not be described in detail herein. Moreover, the various tasks and process steps described herein can be incorporated into a more comprehensive procedure or process having additional steps or functionality not described in detail herein. In particular, various steps in the manufacture of semiconductor devices and semiconductor-based ICs are well known and so, in the interest of brevity, many conventional steps will only be mentioned briefly herein or will be omitted entirely without providing the well-known process details.

Fabrication of the devices discussed herein can comprise multi-step sequences of, for example, photolithographic and/or chemical processing steps that facilitate gradual creation of electronic-based systems, devices, components, and/or circuits in a semiconducting and/or a superconducting device (e.g., an integrated circuit). For instance, the devices discussed herein can be fabricated on one or more substrates (e.g., a silicon (Si) substrates, and/or another substrate) by employing techniques including, but not limited to: photolithography, microlithography, nanolithography, nanoimprint lithography, photomasking techniques, patterning techniques, photoresist techniques (e.g., positive-tone photoresist, negative-tone photoresist, hybrid-tone photoresist, and/or another photoresist technique), etching techniques (e.g., reactive ion etching (RIE), dry etching, wet etching, ion beam etching, plasma etching, laser ablation, and/or another etching technique), evaporation techniques, sputtering techniques, plasma ashing techniques, thermal treatments (e.g., rapid thermal anneal, furnace anneals, thermal oxidation, and/or another thermal treatment), chemical vapor deposition (CVD), atomic layer deposition (ALD), physical vapor deposition (PVD), molecular beam epitaxy (MBE), electrochemical deposition (ECD) or plating, chemical-mechanical planarization (CMP), backgrinding techniques, and/or another technique for fabricating an integrated circuit.

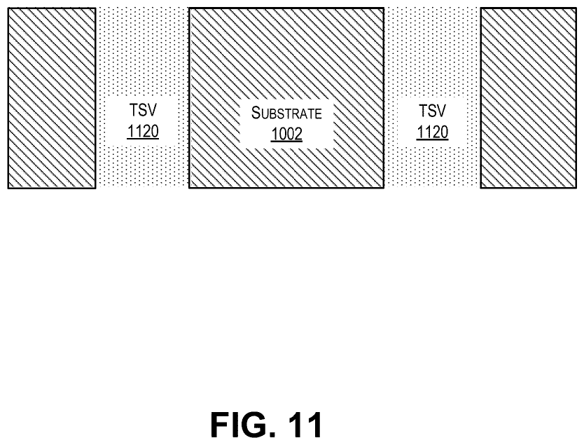

Reference now is made to FIG. 10, which illustrates a substrate 1002 comprising glass or any other material typically used for the fabrication of integrated circuits. The fabrication process begins by providing a pair of substrates which are used to fabricate a top and a bottom electrode probing structure and joined together afterwards as discussed herein. Of course, while the top half and bottom half are described herein as being processed separately, they can also be processed together in view of the descriptions herein. FIG. 10 shows one of the substrates and the fabrication process can be the same for either electrode probing structure 100. Each substrate may possess a top and a bottom surface. Through-substrate vias (TSVs) 1120 are provided from the top surface to the bottom surface of each substrate 1002, as shown in FIG. 11 for one substrate. These vias 1120 serve as channels for electrical connections through the substrate 1002, allowing for integration of multiple layers and connections in subsequent steps. The precise construction of these TSVs 1120 ensures proper alignment and connectivity between the layers of the electrode probing structure 100.

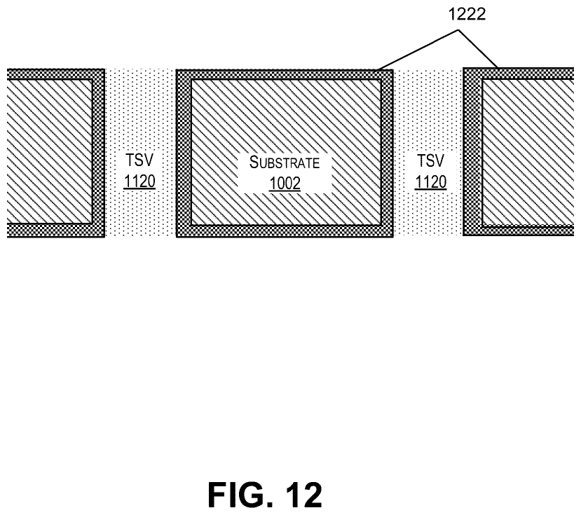

Following the TSV construction, a first insulator layer 1222 is deposited over the entire surface of the substrates 1002 to form an intermediate semiconductor structure of the electrode probing structure 100, including within the TSVs 1120, as shown in FIG. 12. This insulator layer 1222 provides electrical isolation between different metal layers and components.

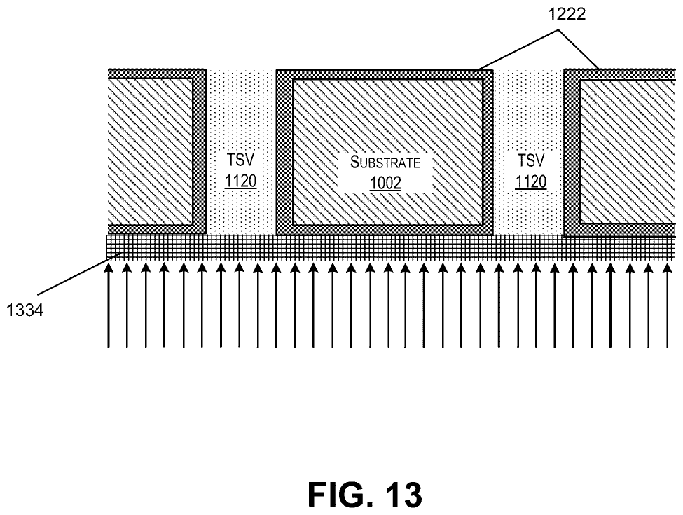

In a next step, shown in FIG. 13, a photoresist 1334 is applied on the bottom surface of the intermediate semiconductor using a mask 1334 to define an area where deposition of a metal seed layer will be bypassed. This step involves coating the bottom surface of the intermediate semiconductor structure with a photoresist and exposing the photoresist 1334 to a pattern of light. The photoresist 1334 defines the areas at the bottom surface where metal seed layer will not be deposited.

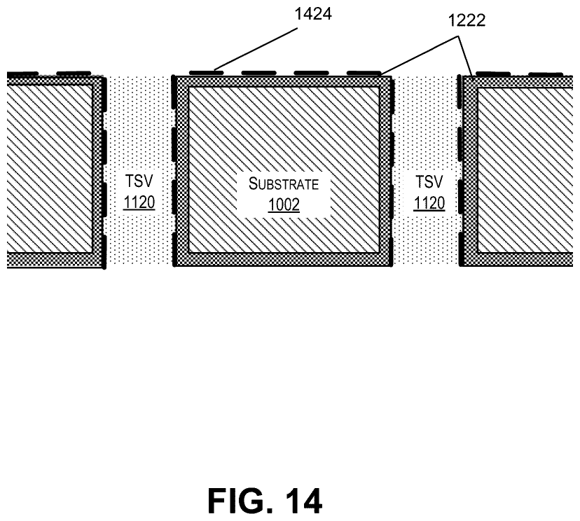

FIG. 14 provides a cross-section view of a semiconductor structure having a metal seed layer 1424, consistent with an illustrative embodiment. More specifically, a metal seed layer 1424 is deposited on the top surface of the intermediate semiconductor structure, including within the TSVs 1120, as in FIG. 14. The metal seed layer 1424 serves as a foundation for subsequent metal plating processes, ensuring good adhesion and uniformity of the metal layers that form the electrodes and other conductive structures.

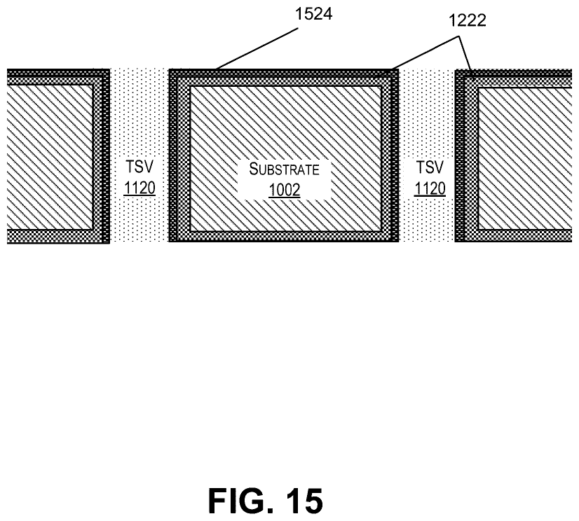

FIG. 15 shows a cross-section of a semiconductor structure having a first metal layer 1524. For example, a first metal layer 1524 is plated from the metal seed layer 1424, covering the top surface of the substrate 1002, including within the TSVs 1120. This first metal layer 1524 forms the main conductive path for the ground shields and their contacts. After the metal deposition, another layer of insulator is deposited over the top and bottom surfaces of the intermediate semiconductor structure, including within the TSVs 1120. This newly deposited insulator layer further electrically isolates the first metal layer 1524 and ensures that the electrodes and contacts are properly insulated from the ground shields and contacts formed on the substrate 1002.

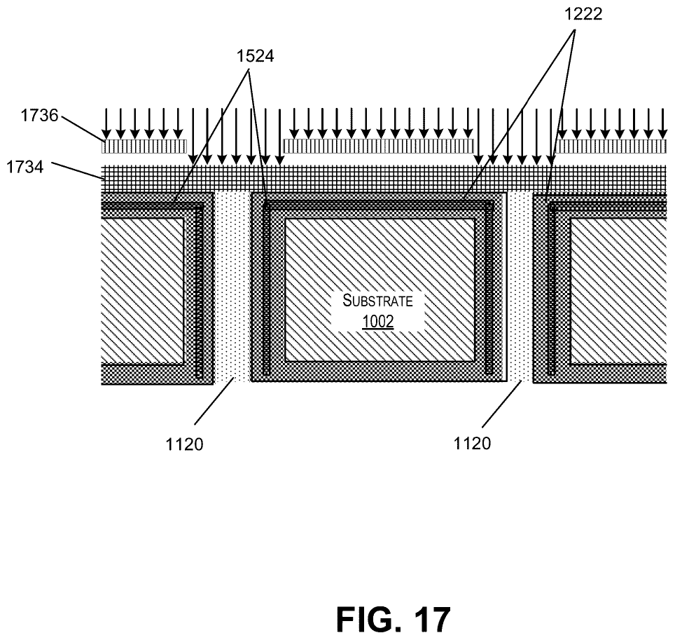

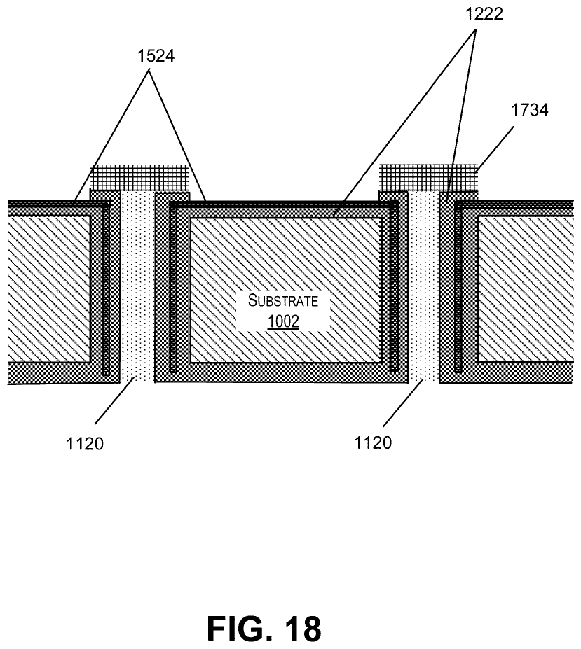

FIG. 17 and FIG. 18 illustrate additional photolithography and etching steps on this insulator layer on the top surface of the substrate 1002, respectively, consistent with an illustrative embodiment. In this way, the patterns for the plurality of electrode contacts and ground shield contacts are defined, thereby ensuring precise alignment and connectivity. The etching process using photoresists 1734 and masks 1736 removes the unwanted portions of the insulator layer, exposing the underlying metal where contacts are to be constructed, while leaving the rest of the insulator intact to provide electrical isolation.

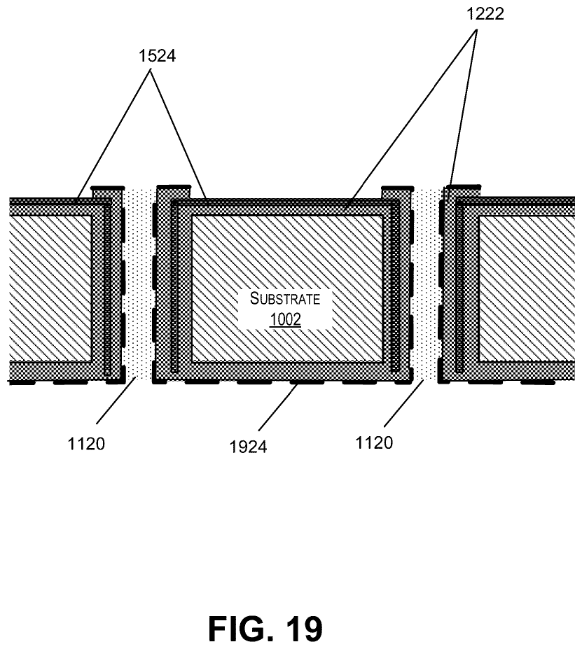

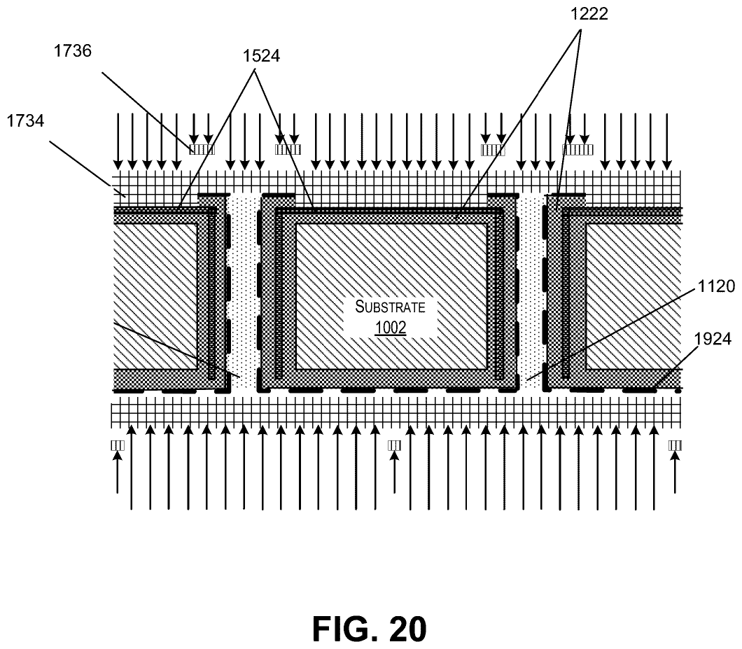

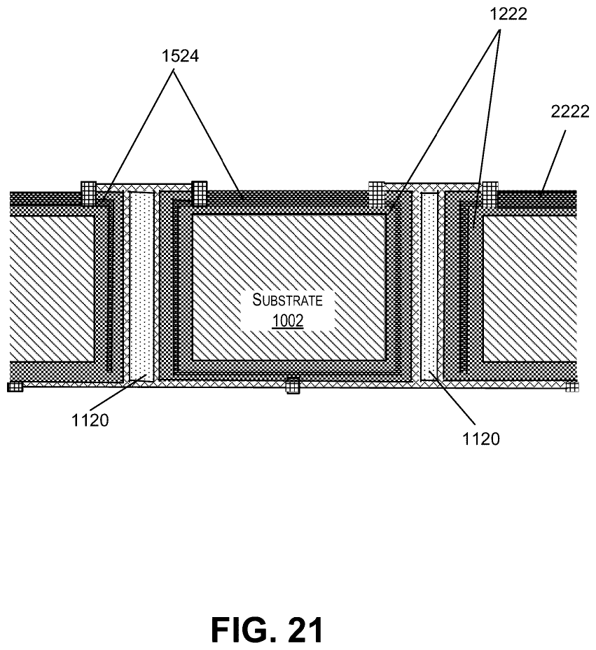

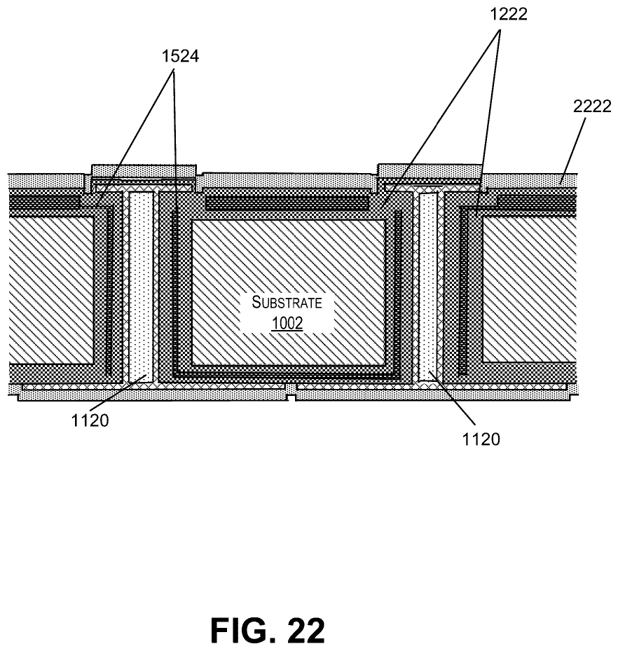

Following this, a metal seed layer 1924 preferably titanium, tantalum or other which is conducive to copper plating growth again on the surface of the intermediate semiconductor structure including the TSVs 1120 as in FIG. 19, ensuring that the next layer of metal adheres well to the portions of the intermediate semiconductor structure covered by the metal seed layer. Using photoresists 1734 and masks 1736, patterns for the electrodes and electrode contacts are generated on both the bottom and top surfaces as shown in FIG. 20. As shown in FIG. 21, metal is plated onto the patterns leaving out areas covered by the masks 1736 to create the electrodes and the electrode contacts. A second insulator layer 2222, which is constructed of a same or different material as that of the first or underlying insulator layers 1222, is then deposited onto the top and bottom surfaces of the intermediate semiconductor structure, as shown in FIG. 22.

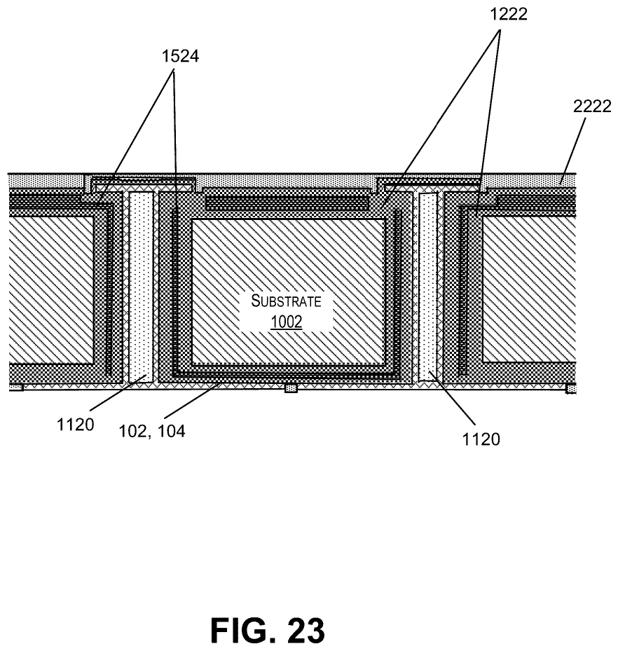

Further as shown in FIG. 23, both the top and bottom surfaces are smoothed by planarization. This act ensures that the electrodes 102, 104 have a flat, even surface, which is crucial for achieving unimpeded laminar flow of particles through the space between the electrodes. Planarization removes any topographical variations and provides a uniform surface for subsequent processing steps and for the final operation of the electrode probing structure 100.

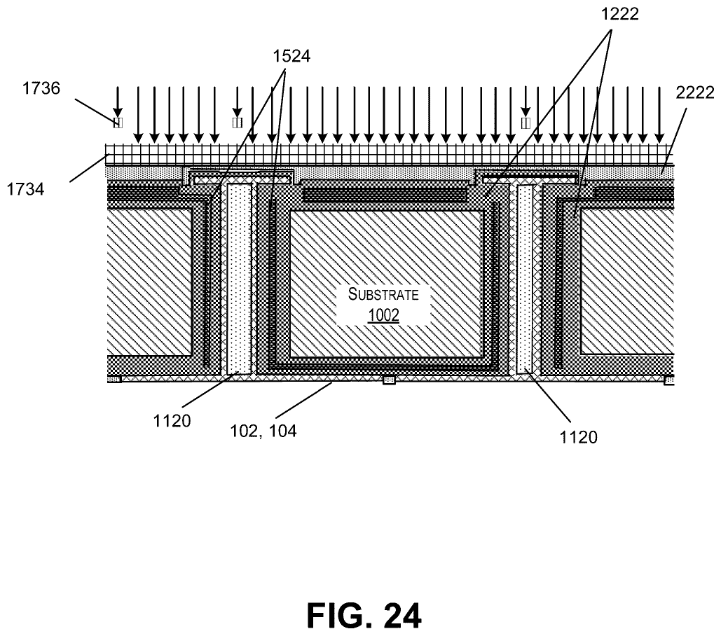

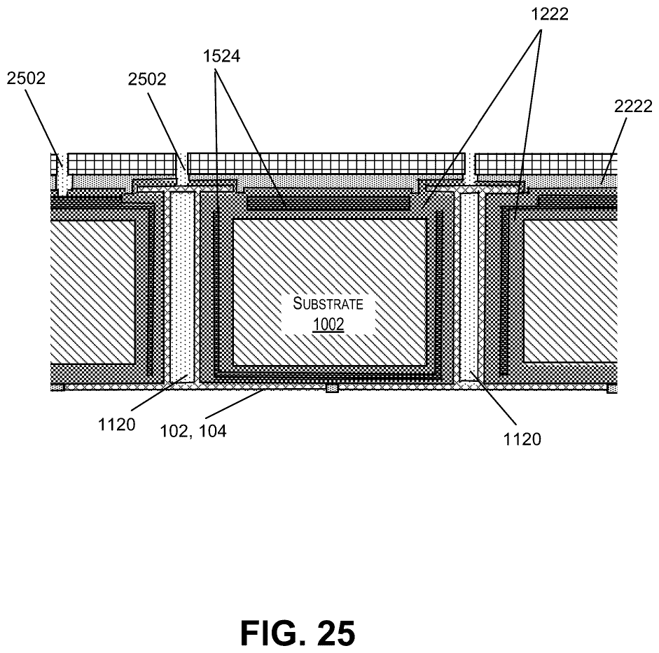

Using photoresist 1734 and masks 1736 at a top surface of the intermediate semiconductor structure, above the second insulator layer 2222 as in FIG. 24, patterns 2502 are generated to define the locations and shapes of the plurality of electrode contacts and ground shield contacts that will be exposed to the external environment, the patterns being shown in FIG. 25. This may enhance precise alignment and connectivity. The etching process removes the unwanted portions of the second insulator layer 2222 and the underlying first insulator layer, exposing the underlying metal where contacts may be made, while leaving the rest of the insulator intact to provide electrical isolation.

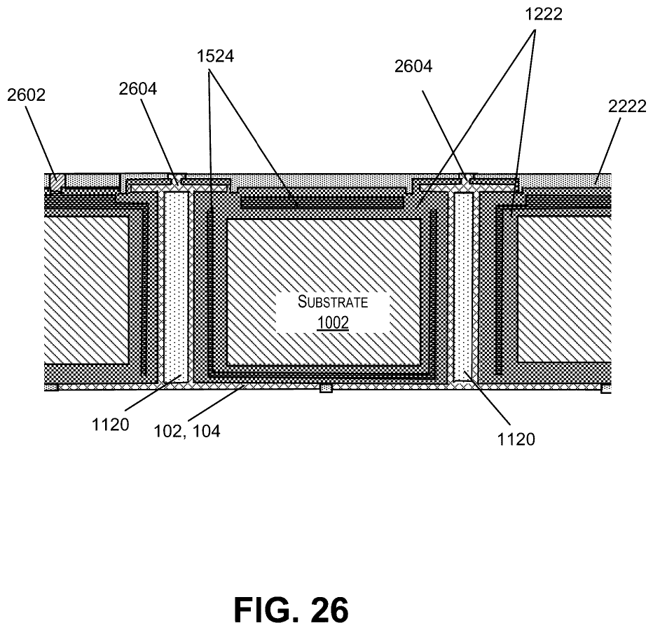

As shown in FIG. 26 a metal deposition using a damascene process is performed to create the plurality of electrode contacts 2602 and ground shield contacts 2604. In this process, metal is deposited into the etched patterns previously generated, filling the spaces where contacts are needed. The damascene process ensures that the metal is deposited precisely and uniformly, creating reliable electrical connections between the various components of the electrode probing structure 100.

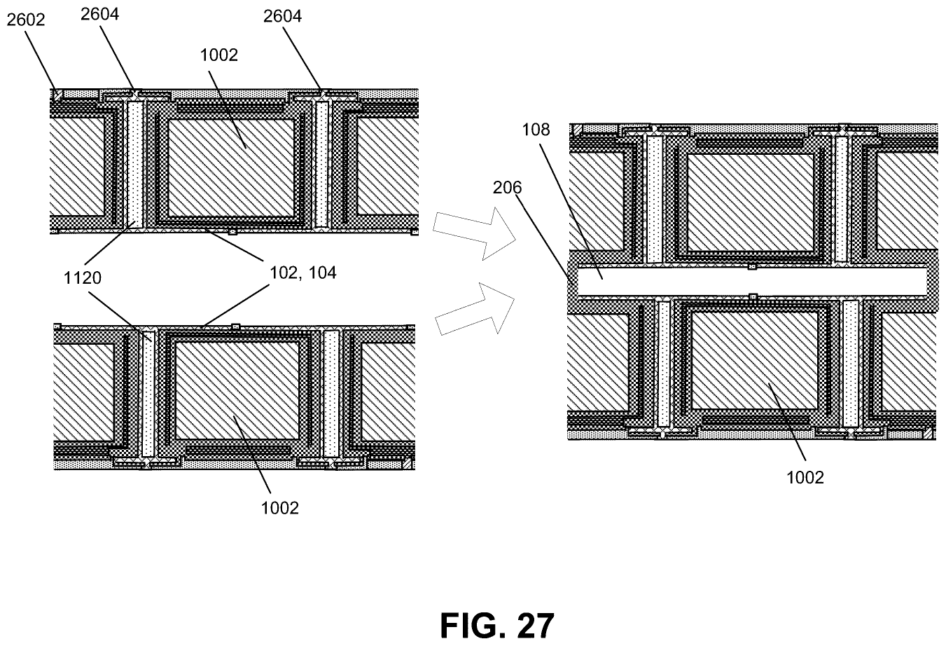

FIG. 27 shows the assembly and bonding of a pair of intermediate semiconductor structures each fabricated separately using methods discussed above. A peripheral spacer 206 made of adjustable or non-adjustable material is used to enclose the space 108 between the electrodes 102, 104, creating a microfluidic channel for particle flow. The height of this channel can be controlled by the thickness of the peripheral spacer 206, allowing for adjustment of the particle flow rate. Bonding the substrates at low temperature forms the final electrode probing structure, ready for operation in microfluidic applications.

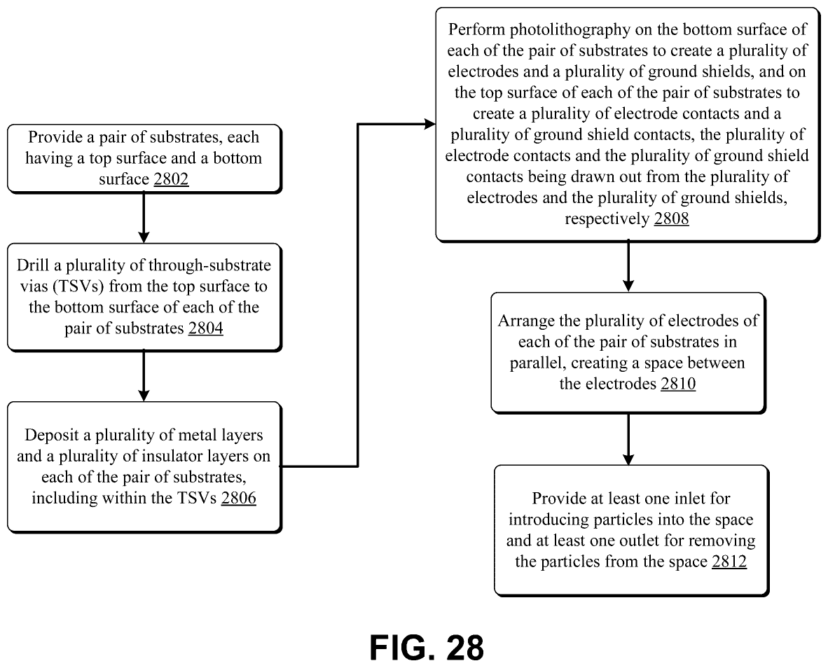

FIG. 28 is a flow chart illustrating the steps of an example method for fabrication of the electrode probing structure 100. The method starts at block 2802 wherein a pair of substrates is provided, each having a top surface and a bottom surface. In block 2804, a plurality of through-substrate vias (TSVs) are constructed from the top surface to the bottom surface of each of the pair of substrates. In the method, a plurality of metal layers and a plurality of insulator layers are deposited on each of the pair of substrates, including within the TSVs, block 2806. In block 2820, photoresists and masks are used a plurality of times to generate a plurality of patterns for generating a plurality of electrodes and a plurality of ground shields, and on the top surface of each of the pair of substrates. A plurality of electrode contacts 2604 and the plurality of ground shield contacts 2602 are drawn out from the plurality of electrodes and the plurality of ground shields, respectively. In block 2810, the plurality of electrodes 102, 104 are arranged in parallel, creating a space between the electrodes. In block 2812, at least one inlet for introducing particles into the space and at least one outlet for removing the particles from the space are provided. In one example, an electric potential may be applied to each pair of parallel electrodes on the pair of substrates to generates signal corresponding to at least one characteristic of the particles present in the space between the parallel electrodes.

In an embodiment, the method and structures as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip may be mounted in a single chip package (such as a plastic carrier, with leads that are affixed to a motherboard or other higher-level carrier) or in a multichip package (such as a ceramic carrier that has either or both surface interconnections or buried interconnections). In any case, the chip can then be integrated with other chips, discrete circuit elements, and/or other signal processing devices as part of either (a) an intermediate product, such as a motherboard, or (b) an end product. The end product can be any product that includes integrated circuit chips, ranging from micro fluid detection applications, such as for detecting particles including virus, protein, DNA, etc., to large scale applications such as for the detection of contaminants in an oil well or in a hydrocarbon fluid. Of course, this is not meant to be limiting as other possibilities may be obtained in view of the descriptions here.

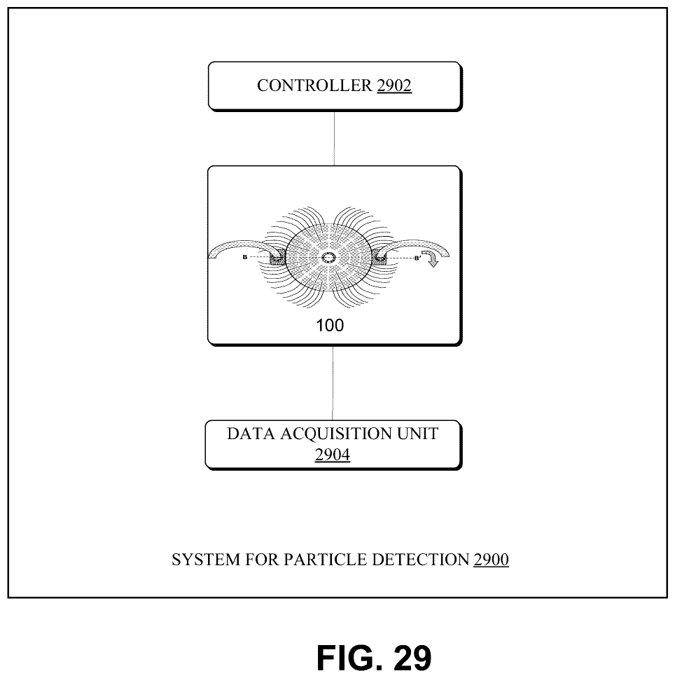

The method may be practiced with a data acquisition system 2900 for particle detection as shown in FIG. 29. The system 2900 can include the electrode probing structure 100 and can integrate several components, including a controller 2902, and a data acquisition unit 2904, to manage particle flow, capture signals, and analyse particle characteristics.

In one method, the first and second arrays of electrodes are arranged in parallel and particles are introduced therebetween and analysed. In the method, the electrodes may be operated to apply electric potentials, e.g. a differential stimulus voltages across each pair, and sensing signals such as capacitance or impedance that can be captured and analysed to determine various particle characteristics.

In the method, the controller 2902 can be operated to manage the flow of particles into and out of the space between the electrode arrays. The controller 2902 can regulate the introduction of particles through the inlet and their exit through the outlet, ensuring a controlled environment for particle analysis. The data acquisition unit 2904 can capture the signals generated by the electrode probing structure 100 when the electric potentials are applied.

In summary, the method can be used for precise and efficient particle analysis in a compact arrangement. Coupling the electrode probing structure 100, with advanced control, data acquisition, and processing capabilities, allows for detailed characterization of particles in a controlled environment and can be particularly suited for applications requiring high accuracy and adaptability, ensuring reliable and comprehensive particle detection and analysis. Any device herein may further comprise a processor that is configured to perform one or more of the methods described.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. An electrode probing structure comprising:
a first array of electrodes arranged to be radially spaced apart about a spatial point;
a second array of electrodes arranged parallel to the first array of electrodes;
a space disposed between the first array of electrodes and the second array of electrodes, the space being a cavity within which a fluid containing particles to be studied is housed;
at least one inlet disposed adjacent the first array of electrodes or the second array of electrodes to introduce the fluid containing particles into the space; and
at least one outlet disposed adjacent the first array of electrodes or the second array of electrodes to remove the fluid containing particles from the space;
wherein each pair of parallel electrodes of the first array of electrodes and the second array of electrodes is configured to generate signals corresponding to at least one characteristic of the particles of the fluid containing particles present in the space upon receiving an electric potential.

2. The electrode probing structure of claim 1, wherein each of the first array of electrodes and the second array of electrodes is arranged coplanar and electrically isolated from each other.

3. The electrode probing structure of claim 1, wherein the inlet is disposed at the spatial point and the outlet is disposed at a periphery of the first array of electrodes and the second array of electrodes.

4. The electrode probing structure of claim 1, wherein a number of electrodes of the first or second array of electrodes and/or an area of each electrode remains constant with each unit increase in radius from the spatial point up to a periphery of the first or the second array of electrodes.

5. The electrode probing structure of claim 1, areas and/or numbers of the first or second array of electrodes change with each unit increase in radius from the spatial point to a periphery of the first or the second array of electrodes.

6. The electrode probing structure of claim 5, wherein an increment in the number of electrodes in the first array of electrodes and the second array of electrodes is constant and an area of each of the electrodes increases with each unit increase in radius up to the periphery.

7. The electrode probing structure of claim 5, wherein the number of electrodes in the first array of electrodes and the second array of electrodes increases linearly or in multiples with each unit increase in radius up to the periphery.

8. The electrode probing structure of claim 7, wherein the area of each of the electrodes in the first array of electrodes and the second array of electrodes decreases with each unit increase in radius up to the periphery.

9. The electrode probing structure of claim 1, wherein the electrodes in each of the first array of electrodes and the second array of electrodes are completely or partially interdigitated with each unit increase in radius from the spatial point up to a periphery of the first or the second array of electrodes.

10. The electrode probing structure of claim 1, wherein the electrodes in each of the first array of electrodes and the second array of electrodes are arranged interdigitated with each unit increase in radius up to a periphery of the first or the second array of electrodes and a number of electrodes in each concentric segment doubles with each unit increase in radius.

11. A method of fabricating an electrode probing structure, comprising:
providing a pair of substrates, each having a top surface and a bottom surface;
providing a plurality of through-substrate vias (TSVs) from the top surface to the bottom surface of each of the pair of substrates;
depositing a plurality of metal layers and a plurality of insulator layers on each of the pair of substrates, including within the TSVs to create a pair of intermediate electrode probing structures;
generating a plurality of electrodes and a plurality of ground shields, on a surface of each of the pair of intermediate electrode probing structures
generating a plurality of electrode contacts and a plurality of ground shield contacts, wherein the plurality of electrode contacts and the plurality of ground shield contacts form an electrical connection with the plurality of electrodes and the plurality of ground shields, respectively;
arranging the plurality of electrodes of each of the pair of intermediate electrode probing structures in parallel, creating a space between the electrodes; and
providing at least one inlet for introducing fluid containing particles to be studied into the space and at least one outlet for removing the fluid containing particles from the space.

12. The method of claim 11, wherein depositing the plurality of metal layers and the plurality of insulator layers on the pair of substrates further comprises:
depositing a first insulator layer over the substrates, including the TSVs
defining a first pattern on the insulator layer at the bottom surface of the intermediate electrode probing structures formed by depositing the first insulator layer;
depositing a metal seed layer around each electrode on the top surface of each of the intermediate electrode probing structures, including within the TSVs;
depositing a metal layer on the metal seed layer covering the top surface of each of the intermediate electrode probing structures, including the TSVs;
depositing a second insulator layer over each of the intermediate electrode probing structures, including the TSVs; and
defining a second pattern on the top surface and etching on the second insulator layer on the top surface of each of the intermediate electrode probing structures based on the second pattern to define areas for generating at least a portion of the plurality of electrode contacts and ground shield contacts.

13. The method of claim 12, further comprising:
depositing a metal seed layer at areas defined by the second pattern including within the TSVs;
plating the metal seed layer with a metal to form the electrodes on one side of the intermediate electrode probing structures the electrodes each being extended to another side of the intermediate electrode probing structures through the TSVs.

14. The method of claim 13, further comprising:
defining a third pattern using at least another set of photoresists and masks to generate locations and shapes of electrode contacts and ground shield contacts at the another side opposite from the one side, and depositing metal based on the third pattern to generate the plurality of electrode contacts and the plurality of ground shield contacts.

15. The method of claim 14, wherein generating the plurality of electrode contacts and the plurality of ground shield contacts through metal deposition is performed using a damascene process.

16. The method of claim 11, wherein creating the space between the electrodes further comprises enclosing the space between the intermediate electrode probing structures using a spacer, the spacer is adjustable to control a width of the space and particle flow rate.

17. The method of claim 11, further comprising applying an electric potential to each pair of parallel electrodes, and measuring signals corresponding to at least one characteristic of the particles of the fluid containing particles present in the space between the parallel electrodes.

18. A system for particle detection, comprising:
an electrode probing structure having a first array of electrodes and a second array of electrodes arranged parallel to the first array of electrodes, defining a space between the first array of electrodes and the second array of electrodes;
at least one controller configured to control a flow of fluid containing particles into and out of the space between the first array of electrodes and the second array of electrodes;
a data acquisition unit configured to receive signals from the electrode probing structure, the signals are generated when an electric potential is applied to each pair of parallel electrodes of the first array of electrodes and the second array of electrodes; and
a processor configured to analyze the received signals to determine at least one characteristic of the particles of the fluid containing particles in the space between the pairs of parallel electrodes.

19. The system of claim 18, wherein the processor is configured to determine characteristics of the particles, including a type, a size, a number, motion characteristics, and a time to completely fill the space between the first and second arrays of electrodes as a function of a particle flow rate.

20. The system of claim 18, wherein the processor is configured to control a width of the space between the first array of electrodes and the second array of electrodes to determine characteristics of the particles based on varying flow rates, from static to dynamic.
